(19) United States
(12) Patent Application Publication
(10) Pub. No.: US 2005/0171937 A1
(43) Pub. Date: Aug. 4, 2005

(54) Memory efficient hashing algorithm

(76) Inventors: Martin W. Hughes, Cary, NC (US); William R. Lee, Apex, NC (US); Trevor Garner, Apex, NC (US); Dennis Briddell, Cary, NC (US)

Correspondence Address: CESARI AND MCKENNA, LLP, 88 BLACK FALCON AVENUE, BOSTON, MA, 02210, US

(21) Appl. No.: 10/769,941

(22) Filed: Feb. 2, 2004

(51) Int. Cl. G06F 17/30

(52) U.S. Cl. 707/3

(57) ABSTRACT

A technique efficiently searches a hash table. Conventionally, a predetermined set of “signature” information is hashed to generate a hash-table index which, in turn, is associated with a corresponding linked list accessible through the hash table. The indexed list is sequentially searched, beginning with the first list entry, until a “matching” list entry is located containing the signature information. For long list lengths, this conventional approach may search a substantially large number of list entries. In contrast, the inventive technique reduces, on average, the number of list entries that are searched to locate the matching list entry. To that end, list entries are partitioned into different groups within each linked list. Thus, by searching only a selected group (e.g., subset) of entries in the indexed list, the technique consumes fewer resources, such as processor bandwidth and processing time, than previous implementations.

### RELATED APPLICATIONS

This application is related to U.S. patent application Ser. No. [Attorney Docket No. 112025-0534], entitled HEADER RANGE CHECK HASH CIRCUIT, by Trevor Garner, et al., the teachings of which are expressly incorporated herein by reference.

### FIELD OF THE INVENTION

This invention relates generally to a technique for searching a data structure, and, more specifically, to searching a hash table having a plurality of linked lists.

### BACKGROUND OF THE INVENTION

A computer network is a geographically distributed collection of interconnected subnetworks for transporting data between nodes, such as computers. A local area network (LAN) is an example of such a subnetwork. The network's topology is defined by an arrangement of client nodes that communicate with one another, typically through one or more intermediate network nodes, such as a router or switch. As used herein, a client node is an endstation node that is configured to originate or terminate communications over the network. In contrast, an intermediate network node is a node that facilitates routing data between client nodes. Communications between nodes are typically effected by exchanging discrete packets of data according to predefined protocols. In this context, a protocol consists of a set of rules defining how the nodes interact with each other.

Each data packet typically comprises “payload” data prepended (“encapsulated”) by at least one network header formatted in accordance with a network communication protocol. The network headers include information that enables the client nodes and intermediate nodes to efficiently route the packet through the computer network. Often, a packet's network headers include at least a data-link (layer 2) header, an internetwork (layer 3) header and a transport (layer 4) header, as defined by the Open Systems Interconnection (OSI) Reference Model. The OSI Reference Model is generally described in more detail in Section 1.1 of the reference book entitled Interconnections Second Edition, by Radia Perlman, published September 1999, which is hereby incorporated by reference as though fully set forth herein.

The data-link header provides information for transmitting the packet over a particular physical link (i.e., a communication medium), such as a point-to-point link, Ethernet link, wireless link, optical link, etc. To that end, the data-link header may specify a pair of “source” and “destination” network interfaces that are connected by the physical link. A network interface contains the mechanical, electrical and signaling circuitry and logic used to couple a network node to one or more physical links. A network interface is often associated with a hardware-specific address, known as a media access control (MAC) address. Accordingly, the source and destination network interfaces in the data-link header are typically represented as source and destination MAC addresses. The data-link header may also store flow control, frame synchronization and error checking information used to manage data transmissions over the physical link.

The internetwork header provides information defining the packet's logical path (or “virtual circuit”) through the computer network. Notably, the path may span multiple physical links. The internetwork header may be formatted according to the Internet Protocol (IP), which specifies IP addresses of both a source and destination node at the end points of the logical path. Thus, the packet may “hop” from node to node along its logical path until it reaches the client node assigned to the destination IP address stored in the packet's internetwork header. After each hop, the source and destination MAC addresses in the packet's data-link header may be updated, as necessary. However, the source and destination IP addresses typically remain unchanged as the packet is transferred from link to link in the network.

The transport header provides information for ensuring that the packet is reliably transmitted from the source node to the destination node. The transport header typically includes, among other things, source and destination port numbers that respectively identify particular software applications executing in the source and destination nodes. More specifically, the packet is generated in the source node by the application assigned to the source port number. Then, the packet is forwarded to the destination node and directed to the application assigned to the destination port number. The transport header also may include error-checking information (i.e., a checksum) and other data-flow control information. For instance, in connection-oriented transport protocols such as the Transmission Control Protocol (TCP), the transport header may store sequencing information that indicates the packet's relative position in a transmitted stream of data packets.

As used herein, a dataflow is a stream of data packets that is communicated from a source node to a destination node. Each packet in the flow satisfies a set of predetermined criteria, e.g., based on the packet's contents, size or relative position (i.e., temporal or spatial) in the data flow. An intermediate network node may be configured to perform “flow-based” routing operations so as to route each packet in a data flow in the same manner. The intermediate node typically receives data packets in the flow and forwards the packets in accordance with predetermined routing information that is distributed using a protocol, such as the Open Shortest Path First (OSPF) protocol. Because each packet in the flow is addressed to the same destination node, the intermediate node need only perform one forwarding decision for the entire data flow, e.g., based on the first packet received in the flow. Thereafter, the intermediate node forwards packets in the data flow based on the flow's previously determined routing information (i.e., adjacency information). In this way, the intermediate node consumes fewer resources, such as processor bandwidth and processing time, than it would if it performed a separate forwarding decision for every packet it receives in the data flow.

In practice, the intermediate network node may implement a hash table which stores packet-related information used to classify received packets into their corresponding data flows. The hash table is typically organized as a table of linked lists, where each list may be indexed by the result of applying a conventional hash function to “signature” information. In this context, a signature is a set of values that remain constant for every packet in a data flow. For example, assume each packet in a first data flow stores the same pair of source and destination IP address values. In this case, a signature for the first data flow may be generated based on the values of these source and destination IP addresses. Likewise, a different signature may be generated for a second data flow whose packets store a different set of source and destination IP addresses than packets in the first data flow. Of course, those skilled in the art will appreciate that a data flow's signature information is not limited to IP addresses and may include other information, such as TCP port numbers, IP version numbers and so forth.

Each linked list in the hash table contains one or more entries, and each linked-list entry stores information corresponding to a particular data flow. Such information may include, inter alia, the data flow's associated signature information and a data-flow identifier (“flow ID”). The flow ID identifies the particular data flow and also may be used to locate routing information associated with the data flow. To that end, the intermediate network node may maintain a data structure that maps flow ID values to the memory locations of their corresponding routing information, e.g., stored in the node's local or internal memory. Alternatively, the flow ID values may directly incorporate the memory locations of their data flows' routing information.

When a packet is received by the intermediate network node, signature information is extracted from the packet's network headers and hashed using a conventional hash function, such as a cyclic redundancy check (CRC) function. The resultant hash value is used to index a hash-table entry which, in turn, references a linked list. Entries in the linked list are accessed sequentially until a “matching” entry is found storing the extracted signature. When a matching linked-list entry is located, the entry's stored flow ID is used to associate the received packet with a data flow and the packet is routed in accordance with that flow.

Conventional flow-based routing, as described above, suffers the disadvantage that the intermediate network node may have to search a large number of linked-list entries before locating a matching entry for the received data packet. For instance, the packet's signature may “collide” with a number of other signature values whose data flows are stored in the same linked list. A plurality of signatures are said to collide when their hash values generate the same hash-table index. Thus, as the number of data flows stored in the hash table increases, so too does the number of collisions. Consequently, the process of searching for the packet's signature may consume an unreasonable amount of time and processing resources due to the large number of list entries that may have to be sequentially traversed.

The above-noted disadvantage of conventional flow-based routing is generally applicable to a broad range of hash-table applications. In other words, there is currently a need for a faster, more efficient technique for locating a hash-table entry containing a desired signature value, without having to traverse as many linked list entries as conventionally required. The technique should reduce the amount of time and resources, such as processor bandwidth and processing time, that an intermediate network node consumes when performing flow-based routing.

### SUMMARY OF THE INVENTION

The present invention provides a technique for efficiently searching a hash table. Conventionally, a predetermined set of “signature” information is hashed to generate a hash-table index which, in turn, is associated with a corresponding linked list accessible through the hash table. The indexed list is sequentially searched, beginning with the first list entry, until a “matching” list entry is located containing the signature information or the end of the linked list is reached. For long list lengths, this conventional approach may search an exorbitant number of list entries. In contrast, the inventive technique reduces, on average, the number of list entries that are searched to locate the matching list entry. To that end, list entries are partitioned into different groups within each linked list. Thus, by searching only a selected group (e.g., subset) of entries in the indexed list, the technique consumes fewer resources, such as processor bandwidth and processing time, than previous implementations.

In accordance with an illustrative embodiment, each linked-list entry in the hash table is associated with a corresponding “direction” value, e.g., equal to zero or one. Each list entry stores, among other things, signature information that is preferably used to derive the entry's corresponding direction value. Illustratively, a predetermined hash function is applied to the signature information, and a designated bit in the generated hash value is extracted as the direction value associated with the list entry. The entry is then inserted into the linked list at a location dependent on the extracted direction value. More specifically, the list is arranged such that entries in the first portion of list are associated with a first direction value (e.g., “0”), and entries in the latter portion of the list are associated with a second direction value (e.g., “1”).

Unlike previous implementations, the list pointer associated with the linked list does not reference the “head” of the linked list, i.e., the first list entry. Instead, the list pointer stores a value that references the list entry located at the boundary where the list's direction values transition from the first direction value to the second direction value. For instance, list entries associated with the first direction value may be inserted to the “left” of the list pointer, and entries associated with the second direction value may be inserted to the “right” of the list pointer (or vice versa). The list entry referenced by the list pointer may correspond to either the first or second direction value. The linked list is preferably implemented as a doubly linked-list, so list entries may be easily inserted on either side of the list pointer, depending on their associated direction values.

Further to the illustrative embodiment, the hash table may be searched to locate a “desired” set of signature information. Operationally, the desired signature information may be hashed to generate an N-bit hash result. A predetermined bit in the generated hash result is extracted and the extracted bit's value is determined to be a direction value associated with the hashed signature information. The remaining N-1 bits of the hash result may be used to generate a hash-table index corresponding to a linked list accessible through the hash table. In accordance with the illustrative embodiment, only those linked-list entries whose associated direction values are equal to the extracted direction value are searched in the indexed list. As noted, list entries on either side of the list pointer correspond to different direction values. Therefore, the extracted direction value can be used to determine in which logical direction (with respect to the list pointer) list entries are sequentially searched to locate a list entry containing the desired signature information. In this way, only a subset of the total number of list entries may be traversed, thereby reducing (on average) the number of list entries that are searched as compared with prior hash-table search techniques, even when the entry is not present in the linked list.

Advantageously, the hash-table searching technique may be employed by an intermediate network node configured to perform flow-based routing, as well as in other hash-table searching deployments. The inventive technique may be implemented in hardware, software or various combinations thereof. It is further noted that the technique provides a more efficient hash-table search technique than conventionally employed, without modifying the contents of the hash-table entries or the linked-list entries, nor changing the memory requirements of the hash table.

### BRIEF DESCRIPTION OF THE DRAWINGS

The above and further advantages of the invention may be better understood by referring to the following description in conjunction with the accompanying drawings in which like reference numerals indicate identically or functionally similar elements, of which:

FIG. 1 is a schematic block diagram of a computer network comprising a collection of interconnected subnetworks and nodes, including an intermediate network node;

FIG. 2 is a schematic block diagram of an illustrative intermediate network node;

FIG. 3 is a schematic block diagram of an exemplary system controller that may be implemented in an intermediate network node;

FIG. 4 is a schematic block diagram of a portion of an exemplary hardware assist circuit that may be implemented within the system controller of FIG. 3;

FIG. 5 is a schematic block diagram of an illustrative hash table that may be accessed in accordance with the present invention;

FIG. 6 is a flowchart illustrating a sequence of steps for inserting a new linked-list entry into a linked list accessible through the hash table, in accordance with the present invention;

FIG. 7 is a flowchart illustrating a sequence of steps for searching linked-list entries accessible through the hash table, in accordance with the present invention;

FIG. 8 is a flowchart illustrating a sequence of steps for deleting a linked-list entry in accordance with the present invention;

FIG. 9 is a flowchart illustrating a sequence of steps for receiving a data packet at an intermediate network node; and

FIGS. 10A-B are a flowchart illustrating a sequence of steps for performing routing operations on a received packet, as set forth in the present invention.

### DETAILED DESCRIPTION OF ILLUSTRATIVE EMBODIMENTS

A. Network Environment

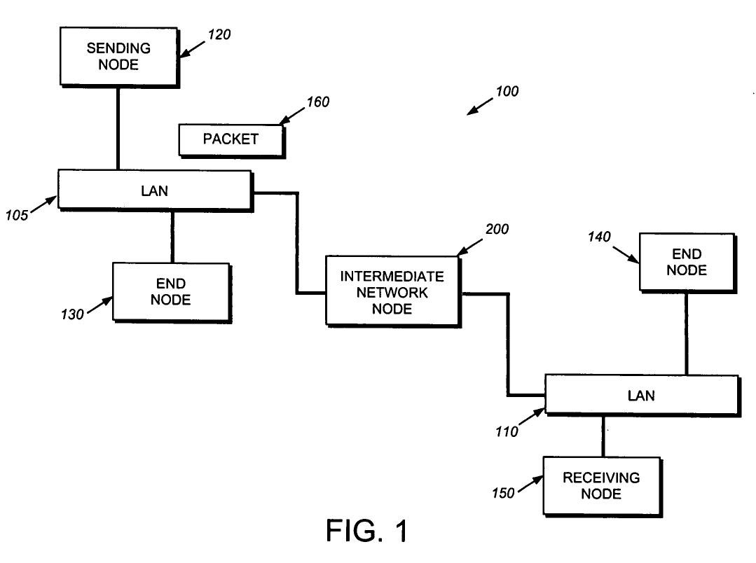

FIG. 1 is a block diagram of a computer network 100 comprising a collection of interconnected subnetworks and nodes. The nodes may comprise computers including end nodes 130 and 140, such as a sending end node 120 and a receiving end node 150, and an intermediate network node 200, the latter of which may be a switch or router. The subnetworks 105, 110 included within network 100 are preferably local area networks (LANs) interconnected by the intermediate node 200, although the networks may comprise other communication links, such as wide area networks. Communication among the nodes coupled to the LANs is typically effected by exchanging discrete packets 160 among the nodes.

For example, the sending node 120 generates a data packet 160 by encapsulating “payload” data within headers, such as conventional data link and internetwork headers, as the data passes through different layers of a protocol stack. The packet is then transmitted over the network to the intermediate node 200 which facilitates the flow of the data packet through the network by routing it to the proper receiving node 150. Specifically, the node 200 receives the packet at one of its network interfaces and renders a forwarding decision for the packet based on a destination end node specified by the packet's internetwork header. The packet's data link header is modified in accordance with the forwarding decision and the packet is transmitted over an appropriate subnetwork coupled to the intermediate network node.

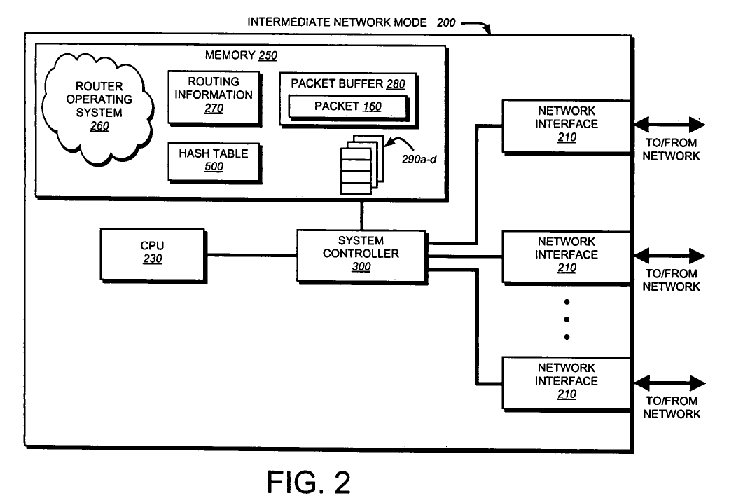

FIG. 2 is a schematic block diagram of an intermediate node 200 that may be advantageously used with the present invention. The node comprises a plurality of network interfaces 210, a system controller 300, a central processing unit (CPU) 230 and a memory 250. Data is received by the network interfaces 210, each of which is coupled to at least one network or subnetwork, such as LANs 105 and 110. The network interfaces contain the mechanical, electrical and signaling circuitry that enables the intermediate network node 200 to communicate over physical links connected to networks and subnetworks, including, inter alia, asynchronous transfer mode (ATM) networks, synchronous optical networks (SONET), wireless networks, frame relay networks, Ethernet networks, Fiber Distributed Data Interface (FDDI) networks, etc.

The system controller 300 is coupled to each network interface 210, the CPU 230 (i.e., a processor) and the memory 250 by different local buses in the intermediate network node 200. For instance, the system controller may be coupled to the network interfaces 210 by respective peripheral component interconnect (PCI) buses, whereas the controller may be coupled to the memory 250 by a plurality of high-speed connections, such as HyperTransport bus links. The controller 300 therefore functions as a “bridge” for transferring data from one local bus to another. That is, the controller receives data over a first local bus, e.g., coupled to a network interface 210, and converts the data to a format that may be transmitted over a second local bus, e.g., coupled to the memory 250. The system controller may also include other functionality, such as application-specific circuitry or logic. Illustratively, the controller 300 may be embodied in hardware as a field-programmable gate array (FPGA) or an application-specific integrated circuit (ASIC), although the controller's functionality alternatively may be implemented in various combinations of hardware and/or software.

The memory 250 comprises a plurality of storage locations that are addressable by the CPU 230 and the network interfaces 210 via the system controller 300. The memory comprises a form of random access memory (RAM) that is generally cleared by a power cycle or other reboot operation (e.g., it is a “volatile” memory). For instance, the memory 250 may comprise dynamic random access memory (DRAM) and/or synchronous DRAM (SDRAM) storage locations adapted to store program code and data structures accessible to the CPU 230. It will be apparent to those skilled in the art that the memory 250 may also comprise other memory means, including various computer-readable media, for storing program instructions and data structures pertaining to the operation of the intermediate network node 200.

A router operating system 260, portions of which are typically resident in the memory 250 and executed by the CPU 230, functionally organizes the intermediate network node 200 by, inter alia, invoking network operations in support of software processes executing on the intermediate node. The IOS™ operating system by Cisco Systems, Inc. is one example of a router operating system 260. The operating system may perform routing operations on data packets 160 received by the network interfaces 210. Accordingly, a portion of the memory 250 may be organized as a “pool” of packet buffers 280 configured to store received data packets. Operationally, a received packet 160 is transferred from a network interface 210 to one or more of the buffers 280, and a memory reference (i.e., a “descriptor”) to the received packet may be stored in an appropriate “ingress” descriptor ring 290a (i.e., a circular first-in, first-out queue). In this manner, the ingress ring 290a records the relative order in which packets are received by the network interfaces and thus the order in which they are processed by the router operating system.

The router operating system 260 dequeues the packet's descriptor from the ingress ring and renders a forwarding decision for the packet based on routing information 270 stored in the memory 250. One or more data structures, such as the hash table 500, may be stored in the memory to facilitate the operating system's forwarding decision. For example, the hash table 500 may be used to identify a data flow associated with the received packet, and the routing information 270 may store adjacency information associated with the identified flow. In this case, the packet's network headers are modified in accordance with the adjacency information associated with the packet's identified data flow. The descriptor for the processed packet is then enqueued in an “egress” descriptor ring 290b that stores the order in which processed packets are forwarded by the intermediate network node 200. When the packet's descriptor reaches the “head” of the egress ring, the descriptor is dequeued from the egress ring and the packet is forwarded over an appropriate network interface 210. It is noted that other ingress and egress data structures besides those described above, also may be stored in the memory 250 to implement packet-queuing operations in the intermediate network node. For instance, such data structures may include hardware-assist ingress and egress data structures 290c and 290d.

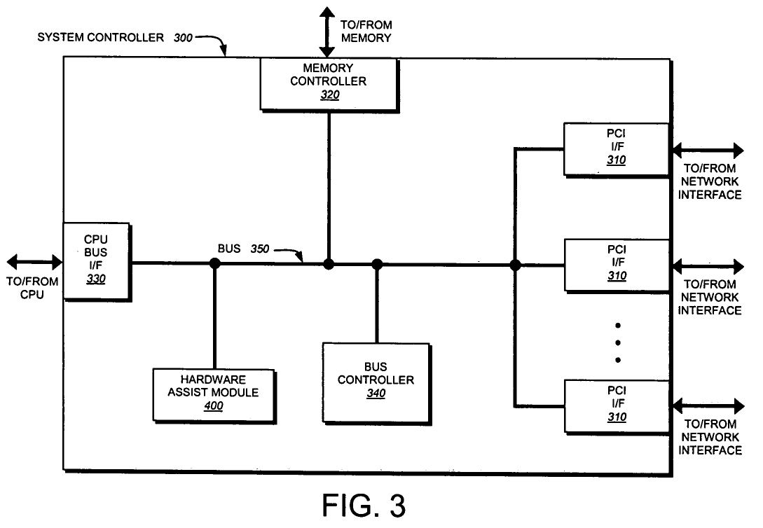

FIG. 3 is a schematic block diagram of a system controller 300 that may be implemented in the illustrative intermediate network node 200. The system controller comprises a plurality of first local bus (PCI) interfaces 310, a memory controller 320, a CPU bus interface 330, a bus controller 340 and a hardware assist module 400 interconnected by a system-controller bus 350. In an illustrative embodiment, each PCI interface 310 includes circuitry and logic configured to send and receive data over a PCI bus coupled to a network interface 210. However, the PCI interfaces 310 alternatively may be substituted for a controller that communicates over other types of buses, such as Industry Standard Architecture (ISA) buses, Extended ISA (EISA) buses, etc. Data received at a network interface 210 is forwarded over a PCI bus to a PCI interface 310, which frames the received data so it may be transferred over the system-controller bus 350. Conversely, each PCI interface may receive data from the bus 350 and reformat the data for transmission over a PCI bus coupled to a network interface.

The memory controller 320 comprises circuitry and logic configured to transfer data from the memory 250 over the second local bus to the system-controller bus 350, and vice versa. For instance, the CPU 230 may forward a memory address (or range of addresses) to the CPU bus interface 330. The memory address may be accompanied by a CPU instruction to read or write data at that memory address. The CPU bus interface 330 transmits the memory address and its corresponding CPU instruction over the system-controller bus 350 to the memory controller 320. In response, the memory controller writes or retrieves data at the specified memory address, in accordance with the CPU instruction.

The bus controller 340 comprises circuitry and logic that, inter alia, implements an arbitration policy for coordinating access to the system-controller bus 350. That is, the controller 340 prevents two or more entities, such as the PCI interfaces 310, memory controller 320, etc., from attempting to access the bus 350 at substantially the same time. To that end, the bus controller 340 may be configured to grant or deny access to the bus 350 based on a predefined arbitration protocol.

According to the illustrative embodiment, the system controller 300 includes a hardware assist (HWA) module 400. Broadly stated, one or more functions normally performed by the router operating system 260 may be “off-loaded” to the HWA module. For instance, in the illustrative embodiment, the module 400 includes circuitry and logic configured to implement a technique for efficiently searching a hash table. In an illustrative embodiment, a received data packet is associated with a corresponding data flow in a manner that enables the router operating system to perform flow-based routing in a more efficient manner than conventionally done.

B. Efficient Hash-Table Retrieval

The present invention provides a technique for efficiently searching a hash table. The hash table is constructed so each hash-table entry is associated with a different linked list, and each linked-list entry stores, inter alia, “signature” information. Conventionally, a desired set of signature information is located in the hash table, as follows: the desired signature is hashed to generate a hash-table index, the generated index is used to locate a linked list accessible through the hash table, and the indexed list is sequentially searched, beginning with its first list entry, until a “matching” list entry is found containing the desired signature information. Advantageously, the inventive technique reduces, on average, the number of list entries that are searched as compared with the above-noted conventional search procedure. To that end, list entries are partitioned into different groups within each linked list, and only a selected group (e.g., subset) of list entries are searched. As such, the technique consumes fewer resources, such as processor bandwidth and processing time, than previous implementations.

In accordance with the illustrative embodiment, each list entry is associated with a corresponding “direction” value, e.g., equal to zero or one. Each list is arranged such that entries in the first portion of the list are associated with a first direction value (e.g., “0”), and entries in the latter portion of the list are associated with a second direction value (e.g., “1”). A list pointer associated with the linked list is configured to store a value that references the list entry located where the list's direction values transition from the first direction value to the second direction value. The list entry referenced by the list pointer may correspond to either the first or second direction value. A desired set of signature information can be located in the list by first associating the desired signature information with a derived direction value, then searching only those list entries whose associated direction values equal the derived direction value. In this way, even when the entry is not found, only a subset of the total number of list entries may be traversed, thereby reducing (on average) the number of list entries that are searched.

For purposes of illustration, the inventive technique is applied to flow-based routing implemented in the intermediate network node 200. In this illustrative embodiment, the process of identifying a packet's associated data flow is “offloaded” from the router operating system 260 to the HWA module 400 in the intermediate network node. As such, the operating system does not consume processor bandwidth or processing time identifying packet flows; consequently, the operating system 260 can better utilize its resources for locating routing information 270 and making forwarding decisions. Furthermore, the HWA module 400 employs the novel technique for identifying packets' data flows, as set forth by the present invention. Specifically, for each data packet 160 processed by the HWA module, the module 400 generates a direction value that may be used to reduce the amount of time and resources traditionally required to locate the packet's data flow in a hash table.

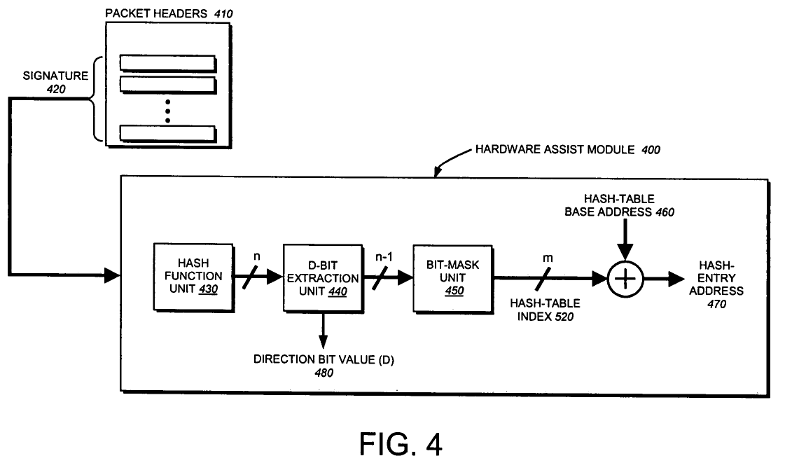

FIG. 4 illustrates a portion of the HWA module 400 that may be used to generate the direction value associated with the received data packet 160. After the packet is received at a network interface 210 and transferred to one or more of the packet buffers 280, the HWA module 400 can extract a set of signature information 420 from predetermined fields in the packet's network headers 410, e.g., the packet's data-link, internetwork and transport headers, or from other packet-related information. For example, the signature information may include the packet's TCP port numbers, IP addresses, etc.

The extracted signature information 420 is input to a hash-function unit 430 in the HWA module 400. The hash-function unit applies a predetermined hash function to the received signature information, thereby generating an n-bit resultant hash value. For example, the hash function may be a conventional CRC-32 hash function that generates a 32-bit hash value (i.e., n=32). In alternate embodiments, the hash function unit 430 may be configured to apply other hash functions, such as the Message Digest 5 function, to the signature information 420.

The hash value generated by the hash-function unit 430 is forwarded to a direction bit (“D bit”) extraction unit 440 which extracts a predetermined “direction” (D) bit 480 from the received n-bit hash value. The resultant (n-1) bit value is then forwarded to a bit-mask unit 450 in the HWA module 400. For instance, suppose the hash-function 430 outputs a 32-bit hash value. In this case, the bit-mask unit 450 receives a 31-bit hash value, after the direction bit 480 has been extracted.

The bit-mask unit 450 selects m bits of the n-1 received hash bits. For example, the bit-mask unit may be configured to select the eight (m=8) least-significant bits of a 31-bit hash value by padding a zero to the most-significant bit of the 31-bit hash value and ANDing this 32-bit value with a “mask” value equal to 0x000000FF (in hexadecimal). The m bits selected by the bit-mask unit may function as a hash-table index 520 that uniquely identifies a specific entry in a hash table having 2^{m} entries. The index 520 may be converted to the memory address 470 of its indexed hash-table entry, e.g., located in the memory 250. For example, assuming each hash-table entry is four bytes wide, the hash-table index 520 times four may be added to the base memory address 460 of the hash table to derive the indexed hash-table entry's memory address 470.

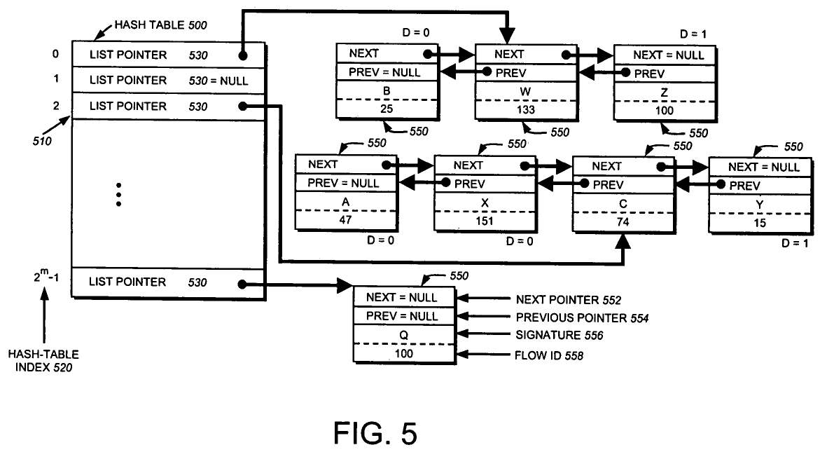

FIG. 5 is a schematic block diagram of a hash table 500 configured to store a plurality of linked lists which may be searched by the HWA module 400. The hash table contains 2^{m} hash-table entries 510, each of which is associated with a unique hash-table index 520 and is configured to store a list pointer value 530 referencing the memory location, e.g., in the memory 250, of a corresponding doubly-linked list. Alternatively, rather than store list pointer values 530, the hash-table entries instead may be configured to directly store the first entry of their referenced linked lists. A hash-table entry's list pointer value 530 may equal a predetermined “NULL” value if its referenced list does not contain any list entries 550, i.e., its referenced linked list is “empty.”

Each linked-list entry 550 in the doubly-linked lists stores, inter alia, a “next” pointer 552, a “previous” pointer 554, signature information 556 and a flow ID value 558. The next pointer 552 stores a value that references an adjacent list entry located in a “forward” list direction. Similarly, the previous (“prev”) pointer 554 stores a value that references an adjacent list entry located in a “backward” list direction. Accordingly, the value of the previous pointer 554 in the list's first entry and the value of the next pointer 552 in the list's last entry may be set equal to predetermined NULL values. It is contemplated that other pointers (not shown) also may be included in the list entry 550. For instance, the list entries may be logically ordered by another set of next and prev pointers (not shown) that link the entries in order of how recently they have been accessed, e.g., in order of least recently used (LRU) entries. This second doubly-linked list may, for example, facilitate aging and deletion operations applied to the list entries 550.

Illustratively, the signature information 556 corresponds to information that may be extracted from a predetermined set of fields in a received packet's network headers 410 or from other relevant packet information. As noted, the signature information may be extracted from selected fields in the packet's layer-2, layer-3, layer-4 or higher-layer headers. For simplicity, the exemplary signature values 556 are depicted symbolically (e.g., A, B, C, etc.), wherein each symbol corresponds to a different set of signature information.

Each set of signature information 556 is associated with a flow ID value 558. As shown, each flow ID value is a numeric value that may be mapped to a corresponding set of routing information 270 (adjacency information), e.g., stored in the memory 250. More specifically, because packets in the same data flow comprise the same signature information, the flow ID value 558 associated with a set of signature information 556 indicates the manner in which packets 160 in that flow are routed by the router operating system 260. Notably, different data flows may be associated with the same flow ID value, i.e., if packets in the flows are routed in the same manner. Also, those skilled in the art will appreciate that the flow ID values 558 may be represented in various implementation-specific ways. For example, each flow ID value may store a pointer value that references the memory location of its corresponding routing information 270.

Advantageously, entries 550 in each doubly-linked list are arranged such that signatures 556 that generate a direction bit value 480 equal to a first value (e.g., “0”) are positioned on a first side of the list pointer 530; signatures that generate a direction bit value 480 equal to a second value (e.g., “1”) are located on the opposite side of the list pointer. The list pointer 530 references a first list entry 550 whose contained signature information 556 may be associated with either the first or second direction bit value 480, e.g., zero or one.

For example, in the top-most illustrated linked list (accessible from the hash-entry 510 whose index 520 equals zero), the list pointer 530 references the first list entry 550 in the list: the “middle” entry 550 which stores the signature “W.” Accordingly, this list entry may be associated with either a direction bit value 480 equal to zero or one. The list also includes two other list entries 550, respectively storing the signatures “B” and “Z.” The list is arranged so that list entries associated with a direction bit value equal to zero are positioned to the left of the list pointer 530, and entries associated with a direction bit value equal to one are positioned to the right of the list pointer. For purposes of explanation, assume the entry 550 storing the signature “B” is associated with a direction bit value equal to zero (D=0) and the entry 550 storing the signature “Z” is associated with a direction bit value equal to one (D=1). Accordingly, the entry 550 containing the signature “B” is located to the left of the list pointer 530 and the entry containing the signature “Z” to the right.

In accordance with the illustrative embodiment, every time a new list entry 550 is inserted into one of the lists, the newly added list entry becomes the list's first list entry, i.e., referenced by the list pointer 530. Therefore, the value of the list pointer 530 is modified to reference the newly added list entry 550 and the new list entry is inserted to an appropriate side of the list's previous first list entry referenced by the list pointer. More specifically, the new list entry is inserted so as to ensure that entries associated with the first and second direction values 480 are positioned on opposite sides of the list pointer 530. For example, in the exemplary linked lists depicted in the hash table 500, if the previous first list entry is associated with a direction bit value equal to one (D=1), then the new list entry is inserted to the left of the previous first list entry. The new list entry is inserted to the right of the previous first list entry if the previous first entry is associated with a direction bit value equal to zero (D=0). In either case, the newly added list entry 550 preferably is positioned immediately adjacent to the previous first list entry. In this manner, list entries 550 are essentially partitioned around the list pointer 530 into two unsorted subsets of zero or more list entries.

Those skilled in the art will appreciate that other techniques may be employed for inserting list entries 550. For instance, the list pointer 530 may be configured to always reference the first list entry 550 added to the list. In other words, the value of the list pointer 530 is not modified upon adding a new list entry 550, unless the added entry is the list's first entry. In such an embodiment, each subsequently added list entry 550 is inserted into the list to an appropriate side of the list's first entry based on the added entry's associated direction bit value 480, e.g., determined by the D-bit extraction unit 440. Accordingly, newly added list entries associated with the first direction bit value are inserted to a first side of the first list entry, and entries associated with the second direction bit value are inserted to a second side of the first list entry.

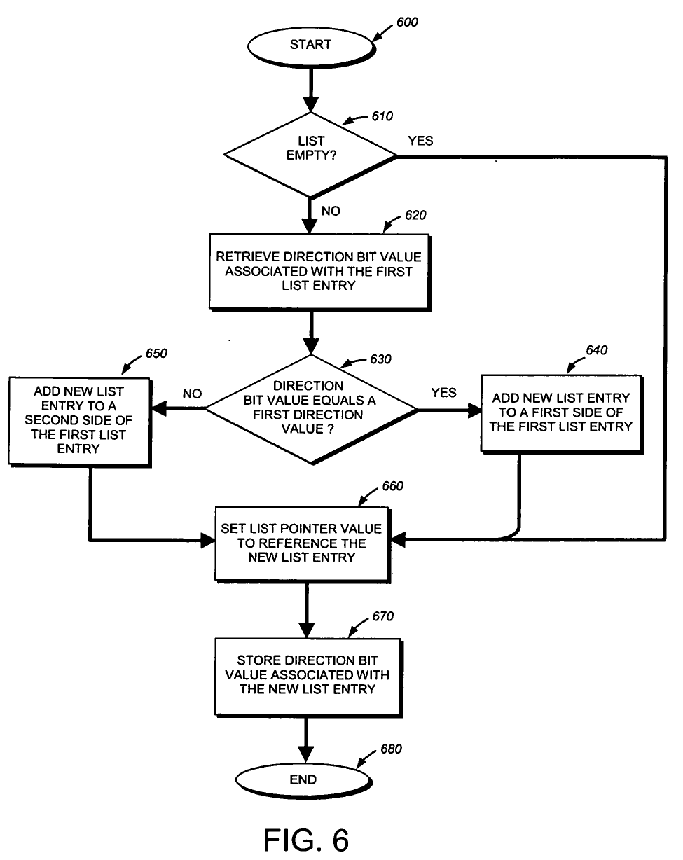

FIG. 6 is a sequence of steps that may be performed for inserting a list entry 550 into a linked list, in accordance with the illustrative embodiment. The sequence starts at step 600 and proceeds to step 610 where it is determined whether the list is empty, i.e., contains zero list entries. The list may be determined to be empty if its associated list pointer 530 equals a predetermined NULL value. If the list is determined to be empty, then the sequence advances to step 660. On the other hand, if the list is not empty, then at step 620 the direction bit value 480 associated with the first list entry, i.e., the entry 550 referenced by the list pointer 530, is retrieved from a predetermined memory location. For example, the direction bit value may be retrieved from a predetermined bit location, i.e., an otherwise unused bit, in the first list entry's associated list pointer 530 or signature information 556. Of course, those skilled in the art will understand that the first list entry's direction bit value 480 may be retrieved from other predetermined memory locations, or alternatively may be generated using the first list entry's signature information 556.

Next, at step 630, it is determined whether the retrieved direction bit value 480 equals a first direction value. If so, the new list entry is inserted to a first side of the first list entry, at step 640. Otherwise, the new list entry is inserted to the other side of the first list entry, at step 650. At step 660, the value of the list pointer 530 is modified to reference the new list entry 550, thereby making the newly added entry 550 the list's first list entry. Then, at step 670, the direction bit value 480 associated with the newly added list entry is stored in a predetermined memory location, such as in a designated bit of the entry's associated list pointer 530 or signature information 556. Notably, if the direction bit value is generated and thus not retrieved at step 620, then step 670 may be skipped. The sequence ends at step 680.

In operation, the hash table 500 may be searched to locate a flow ID value 558 associated with a data packet 160 received by the intermediate network node 200. To that end, signature information 420 is extracted from selected fields of the packet's network headers 410, and the extracted signature information is input to the HWA module 400. Specifically, the module 400 generates a direction bit value 480 and a hash-table index 520 for the received packet. Then, the HWA module locates a list pointer 530 stored in the indexed hash-table entry 510 and searches entries 550 in the linked list referenced by the list pointer 530 to locate a “matching” list entry whose signature information 556 equals the extracted signature information 420.

In accordance with the illustrative embodiment, list entries 550 are partitioned into two different groups around the list pointer 530 based on their associated direction values, thereby reducing the average number of list entries searched by the HWA module 400, e.g., by a factor of two, as compared with conventional hash-table search implementations. More specifically, the HWA module only searches the set of list entries 550 in a logical direction (with respect to the list pointer) determined by the generated direction value 480. For example, if the generated direction value equals one, then list entries 550 in a logical “forward” list direction may be searched; if the generated direction value equals zero, list entries in a logical “backward” direction are searched. In either case, the list entry 550 referenced by the list pointer 530 is searched to determine if it contains the extracted signature information 420.

Having located the matching list entry 550, the HWA module 400 identifies the matching entry's flow ID value 558 and forwards this flow ID value to the router operating system 260, which then routes the received packet 160 accordingly. In the event that the HWA module traverses every linked-list entry 550 in the logical direction determined by the generated direction value 480 without locating a matching list entry, the module 400 may be configured to notify the router operating system, e.g., by setting a flag value in the memory 250, that no matching entry could be found for the received packet 160. In such a case, a new list entry 550 may be inserted into the linked list, e.g., using the steps illustrated in FIG. 6, to associate the received data packet with a new data flow. That is, the new list entry 550 stores signature information 556 and a flow ID value 558 corresponding to the new data flow.

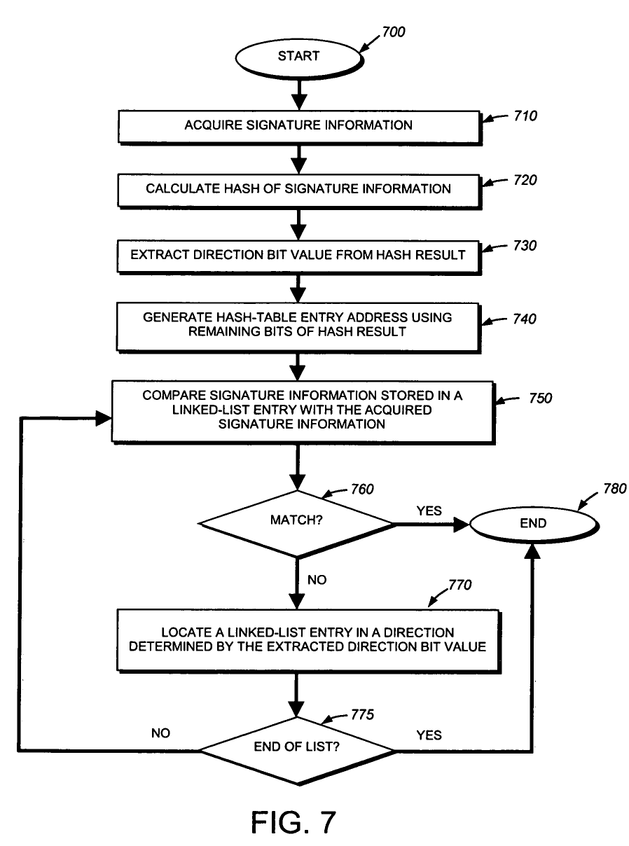

FIG. 7 is a sequence of steps for searching a hash table in accordance with the illustrative embodiment. The sequence starts at step 700 and proceeds to step 710 where a set of signature information is acquired. At step 720, the acquired signature information is hashed, e.g., by a conventional CRC-32 hash function, and a predetermined direction bit is then extracted from the hash result, at step 730. Next, at step 740, the remaining bits of the generated hash value are used to generate a memory address, e.g., in the memory 250, of a hash-table entry 510 configured to store a list pointer value 530. At step 750, signature information 556 stored in the linked-list entry 550 referenced by the list pointer 530 is compared with the acquired set of signature information. At step 760, the list entry is determined to “match” the acquired set of signature information if the acquired set of signature information equals the entry's stored signature information 556. If the signatures are the same, the sequence ends at step 780. Otherwise, at step 770 a linked-list entry 550 is located in a logical direction determined by the extracted direction bit value. Then, at step 775, it is determined whether the end of the list has been reached. If so, the sequence ends at step 780. Steps 750-775 are repeated until a matching list entry is located or the end of the list is reached. The sequence ends at step 780.

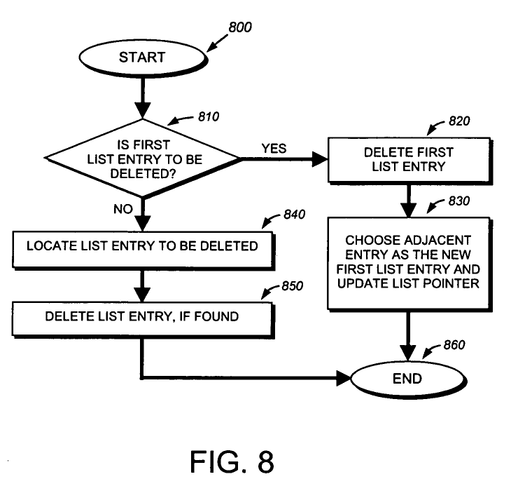

FIG. 8 is a sequence of steps that may be used to delete a list entry 550 from the hash table 500. The entry to be deleted may be identified in various ways. For instance, the entry may be at the head of a LRU queue or list, or timestamp information stored in the entry may identify it as being “stale,” and so forth. Notably, the entry to be deleted may be identified with or without having to search list entries 550 in the hash table 500. The sequence starts at step 800 and proceeds to step 810 where it is determined whether the first list entry is the entry to be deleted. If so, then at step 820 the first list entry is deleted, e.g., and the next and prev pointers 552 and 554 in its neighboring list entries are appropriately adjusted. Then, at step 830, a list entry 550 adjacent to the deleted list entry is selected as the new first list entry. Because there are two possible adjacent entries that may be selected as the new first list entry, one of these adjacent entries may be randomly selected. In an alternate embodiment, the operating system 260 may flip-flop in which logical direction it selects a new first list entry. The sequence ends at step 860.

If, at step 810, the first list entry 550 is not the entry to be deleted, then at step 840 the list entry to be deleted is located. As noted, the entry may be located, e.g., by comparing relative timestamp values stored in the list entries 550, locating the list entry at the “head” of an LRU queue, as well as by other techniques known in the art. At step 850, the list entry is deleted and the next and prev pointers 552 and 554 in its neighboring list entries are appropriately adjusted. The sequence ends at step 860.

C. Flow-Based Routing Using Efficient Hash-Table Range Retrieval

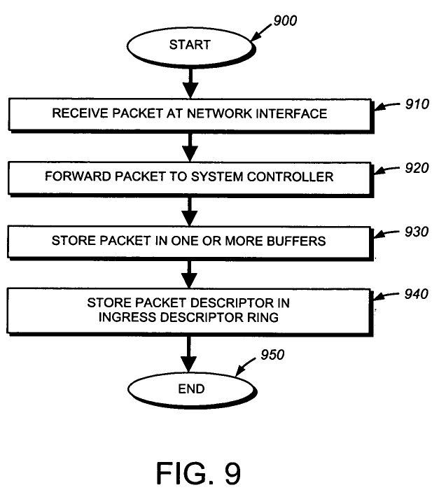

FIG. 9 illustrates a sequence of steps that may be performed by an intermediate node 200 configured to route received data packets using flow-based routing. The sequence starts at step 900 and proceeds to step 910 where a data packet 160 is received, e.g., from a LAN 105 or 110, at a network interface 210 in the intermediate network node. At step 920, the packet is forwarded from the network interface 210 to a system controller 300. The system controller, at step 930, stores the received packet in one or more packet buffers 280 in the intermediate network node's local or internal memory 250. At step 940, the memory location of the packet, i.e., the packet's descriptor, is then stored in an ingress descriptor ring 290a in the memory 250. The sequence ends at step 950.

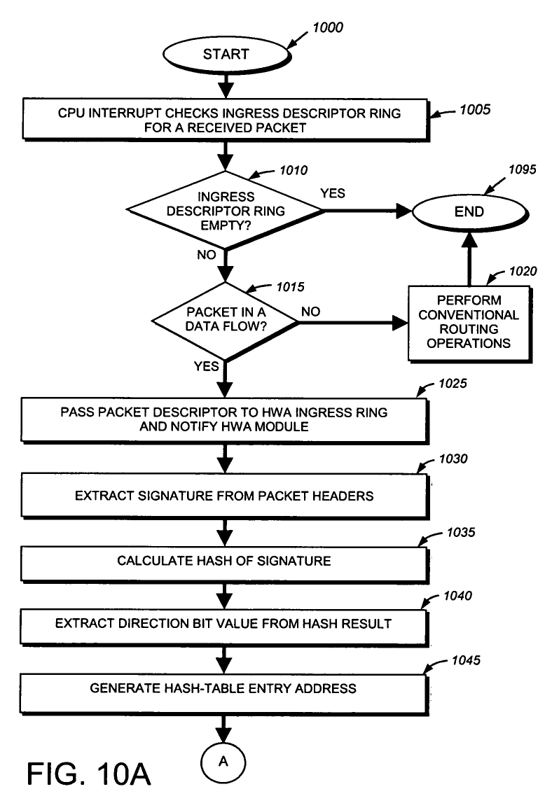

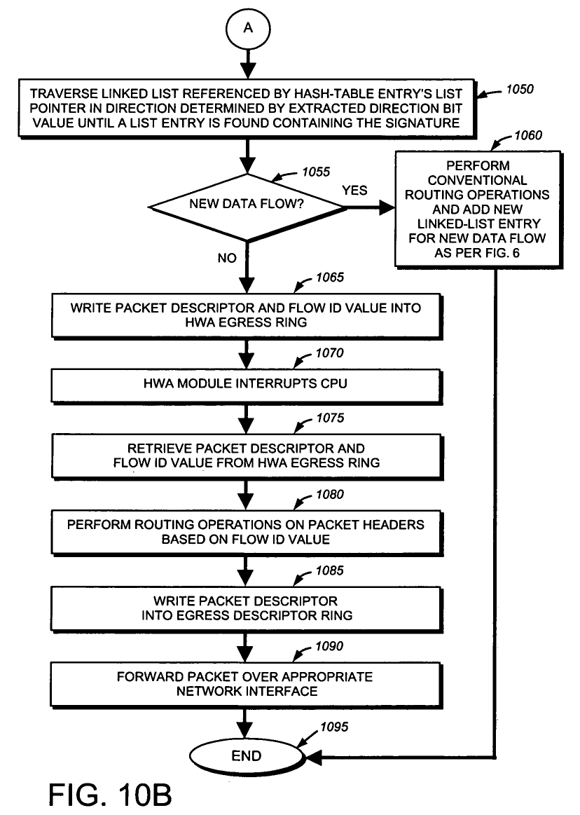

FIGS. 10A-B are a sequence of steps that may be employed by the intermediate network node 200 which is configured to perform flow-based routing in accordance with the present invention. The sequence begins at step 1000 and proceeds to step 1005 where an interrupt signal suspends the CPU's operations so the router operating system 260 can determine whether a new data packet 160 has been received at the intermediate network node 200. Specifically, the operating system identifies a received packet based on the contents of the ingress descriptor ring 290a. If, at step 1010, the operating system determines that the ingress descriptor ring is empty, then the sequence ends at step 1095.

Otherwise, at step 1015, the router operating system 260 locates a descriptor at the “head” of the ingress descriptor ring 290a and makes a determination whether the descriptor references a data packet 160 that is subject to flow-based routing. For example, based on the contents of the packet's headers, the router operating system may determine that the referenced packet is a “one-time” packet or protocol data unit that is not a member of any data flow and is therefore not routed using flow-based routing operations. An example of such a one-time packet is a conventional Address Resolution Protocol (ARP) packet communicated from one intermediate network node to another. If it is determined that the referenced packet 160 is not part of a data flow, then, at step 1020, the operating system 260 may perform conventional routing operations for the packet. In such a case, the packet's descriptor is dequeued from the ingress descriptor ring 290a and the packet is processed and/or forwarded in a conventional manner. The sequence ends at step 1095.

At step 1025, when the descriptor at the head of the ingress descriptor ring 290a references a packet 160 that is subject to flow-based routing, the router operating system dequeues the descriptor and passes it to a HWA ingress ring 290c, e.g., stored in the memory 250. The HWA ingress ring is a circular buffer (i.e., a finite length first-in first-out queue) that stores an ordered list of packet descriptors whose referenced packets may be processed by the HWA module 400. Accordingly, the operating system 260 notifies the HWA module, e.g., by setting an appropriate flag or semaphore value, that a packet descriptor has been added to the HWA ingress ring.

At step 1030, the HWA module 400 extracts signature information 420 from the packet headers 450 of the descriptor's referenced data packet. At step 1035, a hash function, such as a CRC-32 function, is applied to the extracted signature. A predetermined “direction” bit 480 is then extracted from the resultant hash value, at step 1040, and the remaining bits in the hash value are used to generate a memory address 470 of a specific hash-table entry 510 in the hash table 500, at step 1045. To that end, the n-bit hash value may be output from a hash-function unit 430 and subsequently input to a D-bit extraction unit 440 that extracts the direction bit value 480. The remaining n-1 bits of the hash result may be input to a bit mask unit 450 that selects m of the (n-1) hash bits. The hash-entry address 470 may be derived by combining the m masked bits with the hash table 500's base memory address 460, e.g., in the memory 250.

Illustratively, the hash-table entry 510 corresponding to the generated hash-entry address 470 contains a list pointer 530 that references a linked list whose linked-list entries 550 store information related to different data flows. Further, the list is arranged such that a first direction value (e.g., “0”) is associated with every list entry 550 located on a first side of the list entry 550 referenced by the list pointer 530, and a second direction value (e.g., “1”) is associated with every list entry located on the other side of the list pointer's referenced list entry.

At step 1050, the HWA module 400 traverses the linked list referenced by the hash-table entry 510's list pointer 530 in a direction determined by the extracted direction value 480, until a linked-list entry 550 is found that matches the packet 160. The list entry 550 referenced by the list pointer 530 is the first entry traversed, regardless of the value of the extracted direction value 480. A list entry is determined to match the packet 160 if the entry's contained signature information 556 equals the packet's extracted signature 420. If, at step 1055, no matching entry can be found, the HWA module determines that the data packet is a member of a new data flow. In this case, the HWA module 400 notifies the router operating system 260 that a new flow has been identified, and, at step 1060, the operating system performs conventional routing operations for the packet. In addition, the operating system also adds a linked-list entry 550 for the newly identified data flow to an appropriate list in the hash table 500, e.g., as set forth in FIG. 6. Then, the sequence ends at step 1095.

On the other hand, if a matching linked-list entry 550 is identified at step 1050 (and thus the packet is not a member of a new data flow), the HWA module 400 retrieves the packet's associated flow ID value 558 stored at a predetermined offset in the matching list entry. At step 1065, the module 400 writes both the packet descriptor and the packet's identified flow ID value 558 into a HWA egress ring 290d, e.g., a circular first-in first-out queue stored in the memory 250. Next, at step 1070, the HWA module interrupts the CPU 230 so as to notify the router operating system 260 that the packet descriptor and flow ID value have been written to the HWA egress ring. In response, the router operating system 260 retrieves the packet descriptor and flow ID value from the HWA egress ring, at step 1075. Then, at step 1080, the operating system performs routing operations for the packet 160 in accordance with the packet's flow ID value 558. To that end, the operating system may access a data structure, e.g., stored in the memory 250, that “maps” flow ID values 558 to routing information 270 associated with the flow ID values' corresponding data flows.

After the operating system 260 makes a forwarding decision for the packet 160, at step 1085, the packet's headers 410 are updated and the packet's descriptor is written into an egress descriptor ring 290b, e.g., in the memory 250. The packet is then forwarded over an appropriate network interface 210, at step 1090, and its descriptor is removed from the egress descriptor ring. The sequence ends at step 1095. The steps 1000-1095 may be repeated periodically in order to route different data packets received by the intermediate network node 200.

D. Conclusion

The foregoing has been a detailed description of illustrative embodiments of the invention. Various modifications and additions can be made without departing from the spirit and scope of the invention. For example, in the illustrative embodiment the D-bit extraction unit 440 removes a designated “direction” bit 480 from a hashed signature value in order to obtain a direction value. Alternatively, it is also expressly contemplated that other techniques known in the art may be employed for generating the direction value. For instance, transforms that do not use hash functions may be used to generate the direction bit value associated with a set of signature information. Thus, if the direction bit value 480 is not obtained from the hash value generated by the hash function unit 430, the D-bit extraction unit 440 may not have to remove any information from the generated hash value.

While list entries 550 in the illustrative embodiment are partitioned around a list pointer 530 in two unsorted subsets containing zero or more list entries, those skilled in the art will appreciate that the list entries in each subset may be sorted, e.g., according to the contents of their contained signature information 556. Further, it is also noted that the present invention may be used to reduce the number of hash-table entries 510 in the hash table 500 without increasing the average number of list entries that are searched in the hash table. That is, the illustrative embodiment reduces, on average, the number of list entries 550 searched in a hash table 500 having 2^{m} hash-table entries, e.g., by a factor of two. Additionally, the inventive technique may be used in conjunction with a hash table 500 having, e.g., 2^{m-1} hash-table entries, without reducing the average number of list entries 550 searched in the hash table.

Although the hash-table searching technique described herein is applied to flow-based processing, the technique is more generally applicable to any hash-based range searches. For instance, the HWA module 400 in the intermediate network node 200 may be configured to search the hash table 500 for other information besides searching for flow ID values 558. Such other information may include, inter alia, access-control lists, network address translations, intrusion detection information, firewall information, etc.

In addition, the signature information associated with a received packet 160 is not limited to those values stored in fields of the packet's headers 410, e.g., and may be extracted from other portions of the packet's contents or other relevant packet information, such as which interface 210 received the packet. As described, the packet's extracted signature 420 is compared with signature information 556 stored in the linked-list entries 550 until a matching list entry is located. However, it is also contemplated that the linked-list entries alternatively may store the result of hashing the signature information 556. In this case, a matching list entry is identified if its contained signature information 556 equals the result of hashing the packet's extracted signature 420.

Although the inventive technique is described in terms of a single hash table 500, the technique is equally applicable for a plurality of different hash tables that are each configured as set forth in the illustrative embodiment. For instance, a separate hash table 500 may be associated with each network interface 210 in the intermediate network node 200. As such, packets received at a particular network interface may be routed in accordance with flow ID values 558 stored in that network interface's associated hash table. Moreover, in multiprocessor implementations, a plurality of CPUs 230 may access one or more hash tables 500 in accordance with the present invention.

It is expressly contemplated that the teachings of this invention can be implemented as software, including a computer-readable medium having program instructions executing on a computer, hardware, firmware, or a combination thereof. The inventive technique therefore may be implemented in various combinations of hardware and/or software. Accordingly, this description is meant to be taken only by way of example and not to otherwise limit the scope of the invention.

1. A method for efficiently searching a hash table configured to store at least one list containing one or more list entries to locate signature information, the method comprising:
partitioning the one or more list entries into first and second groups of list entries, wherein a first list entry is not associated with either the first group or the second group;
arranging list entries in the first and second groups on opposite sides of the first list entry;
selecting either the first group or the second group based on the contents of the signature information; and
searching list entries in the selected first or second group until a matching list entry is found containing the signature information or the end of the list is reached.

2. The method according to claim 1, wherein list entries in the selected first or second group are not searched if the signature information is contained in the first list entry.

3. The method according to claim 1, wherein list entries in the first group are associated with a first direction value, and list entries in the second group are associated with a second direction value.

4. The method according to claim 3, wherein a list entry's associated direction value is determined by:
applying a hash function to signature information contained in the list entry to generate a hash result; and
identifying the list entry's associated direction value based on the value of a predetermined bit in the generated hash result.

5. The method according to claim 4, wherein the hash function is a CRC-32 hash function.

6. The method according to claim 3, wherein the first group of list entries is selected if a direction value associated with the signature information equals the first direction value, and the second group of list entries is selected if a direction value associated with the signature information equals the second direction value.

7. The method according to claim 6, wherein the direction value associated with the signature information is determined by:
applying a hash function to the signature information to generate a hash result; and
identifying the direction value associated with the signature information based on the value of a predetermined bit in the generated hash result.

8. The method according to claim 7, wherein the hash function is a CRC-32 hash function.

9. A method for efficiently performing flow-based routing operations in an intermediate network node that employs a hash table configured to store at least one list containing one or more list entries, the method comprising:
receiving a data packet at the intermediate network node;
extracting signature information from the received data packet;
generating a direction value and a hash-table entry address based on the contents of the extracted signature information;
locating a first list entry associated with the generated hash-table entry address;
searching list entries, beginning with the first list entry, in a logical direction determined by the value of the generated direction value until a matching list entry is located containing the extracted signature information or the end of the list is reached.

10. The method according to claim 9, further comprising:
identifying a flow identifier stored in the matching list entry; and
routing the received data packet in accordance with the flow identifier stored in the matching list entry.

11. The method according to claim 9, wherein the direction value is generated by:
applying a hash function to the extracted signature information to generate a hash result; and
identifying the direction value based on the value of a predetermined bit in the generated hash result.

12. The method according to claim 11, wherein the hash function is a CRC-32 hash function.

13. The method according to claim 9, wherein the first list entry is located based on a list-pointer value stored at the generated hash-table entry address.

14. The method according to claim 9, wherein if no matching list entry is located containing the extracted signature information, the received data packet is associated with a new data flow and a new list entry associated with the new data flow is inserted into the an appropriate location in the hash table.

15. An intermediate network node configured to perform flow-based processing, the intermediate network node comprising:
a memory adapted to store a hash table configured to store at least one list containing list entries partitioned into first and second groups of list entries, wherein list entries in the first and second groups are situated on opposite sides of a first list entry that is not associated with either the first group or the second group.

16. The intermediate network node according to claim 15, wherein list entries in the first group are associated with a first direction value, and list entries in the second group are associated with a second direction value.

17. The intermediate network node according to claim 16, wherein a new list entry is inserted into the list by:
obtaining a direction value associated with the first list entry;
inserting the new list entry to a first side of the first list entry if the obtained direction value equals the first direction value;
inserting the new list entry to a second side of the first list entry if the obtained direction value equals the second direction value; and
redefining the first list entry, in response to inserting the new list entry, so the new list entry is the first list entry in the list.

18. The intermediate network node according to claim 17, wherein the direction value associated with the first list entry is obtained by retrieving the direction value from a predetermined memory location.

19. The intermediate network node according to claim 17, wherein the direction value associated with the first list entry is obtained by generating the direction value based on signature information stored in the first list entry.

20. The intermediate network node according to claim 16, wherein a new list entry is inserted into the list by:
associating the new list entry with the first direction value or the second direction value;
inserting the new list entry to the side of the first list entry corresponding to the first group if the new list entry is associated with the first direction value; and
inserting the new list entry to the side of the first list entry corresponding to the second group if the new list entry is associated with the second direction value.

21. The intermediate network node according to claim 16, wherein list entries in the list are searched to locate signature information by:
selecting either the first group or the second group based on the contents of the signature information; and
searching list entries, beginning with the first list entry, in the selected first or second group until a matching list entry is found containing the signature information or the end of the list is reached.

22. The intermediate network node according to claim 16, wherein a list entry is deleted from the list by:
determining whether the list entry to be deleted is the first list entry in the list;
if the list entry to be deleted is the first list entry, performing the steps:
(i) deleting the first list entry, and
(ii) choosing a list entry adjacent to the first list entry to be the new first list entry in the list; and
if the list entry to be deleted is not the first list entry in the list, performing the steps:
(i) locating the list entry to be deleted, and
(ii) deleting the located list entry.

23. An apparatus for efficiently searching a hash table configured to store at least one list containing one or more list entries to locate signature information, the method comprising:
means for partitioning the one or more list entries into first and second groups of list entries, wherein a first list entry is not associated with either the first group or the second group;
means for arranging list entries in the first and second groups on opposite sides of the first list entry;
means for selecting either the first group or the second group based on the contents of the signature information; and
means for searching list entries in the selected first or second group until a matching list entry is found containing the signature information or the end of the list is reached.

24. A computer-readable media including instructions for execution by a processor, the instructions for a method of efficiently searching a hash table, the method comprising:
partitioning the one or more list entries into first and second groups of list entries, wherein a first list entry is not associated with either the first group or the second group;
arranging list entries in the first and second groups on opposite sides of the first list entry;
selecting either the first group or the second group based on the contents of the signature information; and
searching list entries in the selected first or second group until a matching list entry is found containing the signature information or the end of the list is reached.
